(19) United States
(12) Patent Application Publication
(10) Pub. No.: US 2012/0111361 A1
(43) Pub. Date: May 10, 2012

(54) METHOD FOR SUBSTRATE SURFACE CLEANING

(76) Inventors: Helmuth Treichel, Fremont, CA (US); Flint Thorne, Fremont, CA (US); Rito Ligutom, Fremont, CA (US); Jim Swertel, Fremont, CA (US)

(21) Appl. No.: 13/041,166

(22) Filed: Mar. 4, 2011

Related U.S. Application Data
(63) Continuation of application No. 12/943,868, filed on Nov. 10, 2010.

(51) Int. Cl. B08B 7/00; B24B 1/00

(52) U.S. Cl. 134/6; 451/57

(57) ABSTRACT

A method for cleaning and polishing a disk is provided. The method includes planarizing the disk and transferring the planarized disk to a first station of a polishing module. At the first station opposing sides of the disk are simultaneously polished as the disk rotates around an axis of the disk. The polishing includes continuously advancing a first polishing member contacting a first surface of the disk and a second polishing member contacting a second surface of the disk, wherein the advancing of the first polishing member independent of the advancing of the second polishing member. The method includes transferring the disk to a second station of the polishing module.

### CLAIM OF PRIORITY

This application is a continuation of and claims priority from U.S. application Ser. No. 12/943,868, filed on Nov. 10, 2010, which is hereby incorporated by reference.

### BACKGROUND

Many processes for semiconductor and disk manufacturing require extremely clean workpieces before the processes may start. For example, particulates or contaminants that attach to, or form on, the workpiece before processing may eventually cause defects in the workpiece. When the workpieces are disks to be processed, such particulates or contaminants may be materials adhered to the workpiece due to the polishing operation. These particulates or contaminants may also be embedded in the substrate, and thus be more difficult to remove before the processing. Any of these defects not only lower the effectiveness of the magnetic layer to store the information but also can cause the crash of read-write heads that are flying over the platen at typically 1-2 nm fly height. Any nanoasperity is equivalent to an insurmountable mountain to avoid. Therefore, the surface roughness after a polish process is often required to be less than 1 Å.

Cleaning, then, is a process intended to remove substantially all of such particulates or contaminants from workpieces before processing, such as processing of magnetic media or semiconductor workpieces. A clean workpiece is thus a workpiece from which substantially all of such particulates or contaminants have been removed before processing.

Therefore, there is a need for improving techniques for cleaning workpieces, such as those workpieces that present problems and require removal of substantially all of such particulates or contaminants from the workpieces before processing. Moreover, these improved techniques must allow cleaning of a workpiece to be done quickly so as to reduce the cost of capital equipment for the cleaning and to provide a clean substrate to alleviate additional process burdens during downstream media processing.

It is within this context that embodiments of the invention arise.

### SUMMARY OF THE INVENTION

Broadly speaking, embodiments of the present invention fill these needs by providing methods of and apparatus configured to efficiently clean workpieces, especially substrates for the disk drive manufacturing process.

In one embodiment, a method for cleaning and polishing a disk is provided. The method includes planarizing the disk and transferring the planarized disk to a first station of a polishing module. At the first station opposing sides of the disk are simultaneously polished as the disk rotates around an axis of the disk. The polishing includes continuously advancing a first polishing member contacting a first surface of the disk and a second polishing member contacting a second surface of the disk, wherein the advancing of the first polishing member independent of the advancing of the second polishing member. The method includes transferring the disk to a second station of the polishing module.

In another embodiment, a method for cleaning a disk is provided. The method includes planarizing the disk and transferring the disk to a first station of a polishing module wherein the disk is vertically oriented. The method includes contemporaneously polishing opposing sides of the disk as the disk rotates around an axis of the disk and linearly advancing opposing polishing membranes independently during the polishing, wherein the linearly advancing occurs in an opposing direction to a direction of rotation of the disk. A liquid is delivered to each of the opposing sides proximate to a contact point of each of the polishing membranes during the polishing. In one embodiment, a pressure applied to a backside of each of the polishing membranes is independently adjusted for each side during the polishing. The method includes transferring the disk to a second station of the polishing module and wiping opposing sides of the disk as the disk rotates around an axis of the disk.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a flowchart diagram illustrating a high level view of the process of manufacturing a hard drive disk in order to prepare the hard drive disk for disposal of media onto the surface of the hard drive disk in accordance with one embodiment of the invention.

FIG. 2 is a flowchart diagram illustrating the enhanced polish and washing operation in accordance with one embodiment of the invention.

FIG. 3 illustrates a cascade scrubber system within a system enclosure in accordance with one embodiment of the invention.

FIGS. 4A and 4B each show a single cascade scrubber assembly in accordance with two embodiments of the present invention.

FIG. 5A shows a cross-sectional view of one zone of a cascade scrubber assembly, in accordance with one embodiment of the present invention.

FIG. 5B shows the processing of larger substrates as might be used in larger semiconductor wafers in accordance with one embodiment of the present invention.

FIG. 6A illustrates an alternative cascade scrubbing system, in accordance with one embodiment of the present invention.

FIG. 6B illustrates a three-dimensional view of the alternative cascade scrubbing system.

FIG. 7 is a simplified schematic diagram illustrating an orientation of one row of brushes for a cascade scrubber in accordance with one embodiment of the invention.

FIG. 8 is a simplified schematic diagram illustrating an alternative polishing module for use in the enhanced polishing washing scheme in accordance with one embodiment of the invention.

FIG. 9 is a simplified schematic diagram illustrating a batch scrubbing module that may be utilized to perform the enhanced polishing and washing operations in accordance with one embodiment of the invention.

FIG. 10A is a simplified schematic diagram illustrating a wafer cleaning cascade station having integrated edge cleaners in accordance with one embodiment of the invention.

FIG. 10B is a simplified schematic diagram illustrating a cross-sectional view through station three of FIG. 10A in accordance with one embodiment of the invention.

FIGS. 11A through 11C illustrate various embodiments for support of the edge scrub brush mechanism in accordance with one embodiment of the invention.

FIG. 12 is a simplified schematic diagram illustrating a top view of a four-lane transport system having edge scrub cleaning capability in accordance with one embodiment of the invention.

### DETAILED DESCRIPTION

The embodiments described below relate to an apparatus for cleaning a workpiece. In one embodiment, the apparatus may be used to clean magnetic disks that store data. It should be appreciated that the embodiments are not limited to cleaning magnetic disks, in that any semiconductor circuit device, flat panel display, or other substrate may be supported for cleaning by the embodiments described herein. The terms workpiece, wafer, and disks, as used herein may refer to any substrate being processed. In addition, the terms disk and disc are used interchangeably, and may also reference any such substrate or workpiece. The term brush or pad may be used interchangeably in the embodiments described below also.

CMP slurries contain abrasive particles to perform the mechanical removal of the surface material. These abrasive particles must be removed from the substrate surface after polishing to prevent defects. In one embodiment, after CMP, the substrates are kept wet prior to cleaning because once the slurry is allowed to dry on the wafer; the dried slurry is difficult to remove mechanically. Due to electrostatic attraction forces simply rinsing the wafers with water after polishing will remove little if any of those particles. Modern production equipment use systems with brush cleaners to clean and dry the wafers after CMP. These tools use polyvinyl alcohol (PVA) brushes to mechanically wipe the surface of the wafer and remove the abrasive particles. Additionally, dilute ammonium hydroxide may be used to reduce the electrostatic attraction of the slurry particles to the wafer surface.

The embedding of slurry particles that occurs during the polishing process of the substrate cannot be reduced by texture processing, and thus it is expected that the SNR (signal-to-noise ratio) will decrease significantly. Accordingly, embedded particles, contamination (e.g., dried slurry), scratches, and other forms of defects (micro defects), are left on the substrate surface. Embedding of the slurry particles indicates a state in which the particles are embedded into and remain in the substrate. Such embedding of the particles into the substrate causes a defect in the medium and a reduction in the magnetic characteristics. If the substrate dries, the embedded particles, contamination, and other forms of defects (micro defects), that are left on the surface are also dried-up, making them stick to the surface. These embedded particles are difficult to remove during the succeeding cleaning process at the media site. Scratches may be caused by coarse slurry particles that are carried-over to the 2^{nd} Step Polish operation.

The embodiments address these issues by providing an intermediate pre-cleaner/surface conditioner tool between the first step polishing operation and the second step polishing operation in order to enhance the cleaning effectiveness. The embodiments can be used in the processing of substrates ranging from silicon wafers used in semiconductor manufacturing, to aluminum, ceramic, plastic, glass, composite, multi-component disks and the like used in the fabrication of data storage devices such as hard drive disks (HDDs), compact discs (CDs), digital versatile discs (DVDs) and the like used in the information, computer and entertainment industries. As used herein, the term “disk” is used as all-inclusive of any of the various substrates used in the media and data storage fields, and including HDDs, CDs, DVDs, mini-discs, and the like. Throughout this Detailed Description, “substrate” is used in a generic sense to include both wafers and disks (also referred to as discs) and denoted 108. In some instances, substrates specified to be wafers are denoted 108′, and substrates specified to be disks are denoted 108″. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

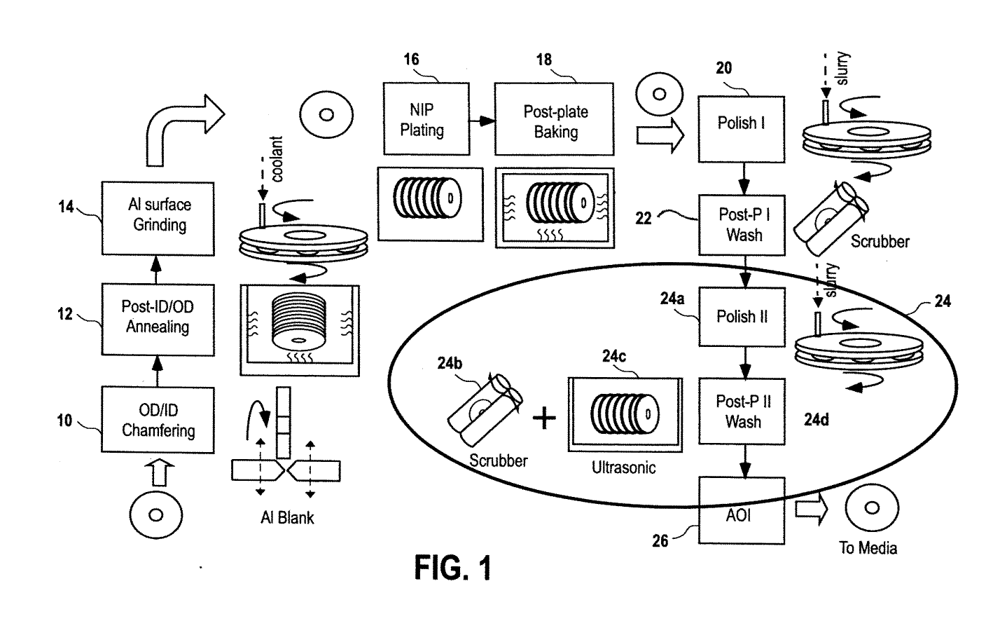

FIG. 1 is a flowchart diagram illustrating a high level view of the process of manufacturing a HDD in order to prepare the hard drive disk for disposal of media onto the surface of the hard drive disk in accordance with one embodiment of the invention. The method illustrated in FIG. 1 initiates with outer diameter\inner diameter chamfering in operation 10. The method then advances to operation 12 where post inner diameter/outer diameter annealing occurs. In operation 14 aluminum surface grinding takes place. In operation 16 a nickel phosphorus layer is plated over the surfaces of the aluminum substrates. The method then proceeds to operation 18 where post plate baking occurs. Proceeding to operations 20, 22, and 24, a series of polish and post-wash operations are provided. The embodiments described herein provide for an enhanced polishing/surface conditioning and washing operation where the operations may take place in an integrated cleaner in accordance with one embodiment of the invention or as a separate intermediate tool employed between the first and second polishing operations. Returning to FIG. 1, in operation 20, a polishing operation is executed where the surface of the hard drive disk (HDD) is planarized and then cleaned in operation 22. In one embodiment, the cleaning operation may take place in an enhanced cascade scrubber that is described in more detail below. The polish operation 20 is a rough polishing process that has high removal rate, but poor surface quality. The polishing process utilizes the CMP (Chemical Mechanical Polisher) tool, the substrate to polish, and the ingredients to perform polishing, i.e., polishing pads (Pads1), slurries (Slurry1), and De-ionized (DI) water. The raw substrates may be polished using polishing pads which are mounted on steel platens, in one embodiment. In this embodiment, there are two platens, one on top and the other at the bottom. The substrates are placed in between the two platens so that the top and bottom surfaces of the substrate are polished at the same time. The platens are rotated against each other, and pressure is applied between them. The substrate is also rotated within the polishing pads. To improve the substrate's stock removal, slurries containing abrasives and chemicals are introduced into the polishing process. Towards the end of this process, the slurry feed is generally ended, then DI water is introduced to rinse the substrates and clean the polishing pads. At the end of this process, the platens are separated, the substrates are removed and then transported to the next operation. The cleaning process 22 is generally a scrubbing process using soft PVA brushes, then spraying using De-Ionized water to remove most of the 1^{st} step polishing slurries and other contaminants from the substrate. After the cleaning operation in operation 22 a second polish operation is performed in operation 24a.

The fine polishing process of operation 22 has the objective to reduce the surface roughness. This is similar to the Rough Polish process 20, except for the following key differences: 1.) polishing pads (Pads2), and 2.) slurries (Slurry2). The polishing pads and slurries are designed to achieve very low surface roughness (around 1 Angstrom). This process is designed for very low stock removal to produce very smooth surfaces. The second polish operation is followed by a second cleaning operation as illustrated in operation 24d. Operation 24d consists of the scrubbing operation 24b and the ultrasonic cleaning operation 24c, which provide for the integrated polishing and cleaning operation described further below. The cleaning process may include a series of Immersion in chemical baths may be enhanced with ultrasonic/megasonic energy, then Scrubbing and Rinsing actions which are designed to remove the 2^{nd} step slurries and other contaminants from the substrate. Upon completion of the second polish and cleaning operation, the method advances to operation 26 where automatic optical inspection (AOI) is performed prior to providing the polished and cleaned HDDs for media deposition. In one embodiment, drying operations may be included after the cleaning process where the drying process may be any of the following processes: 1.) spin dry, 2.) vapor drying, 3.) Cold DI Drying, 4.) Hot DI drying, or 5.) Marangoni drying.

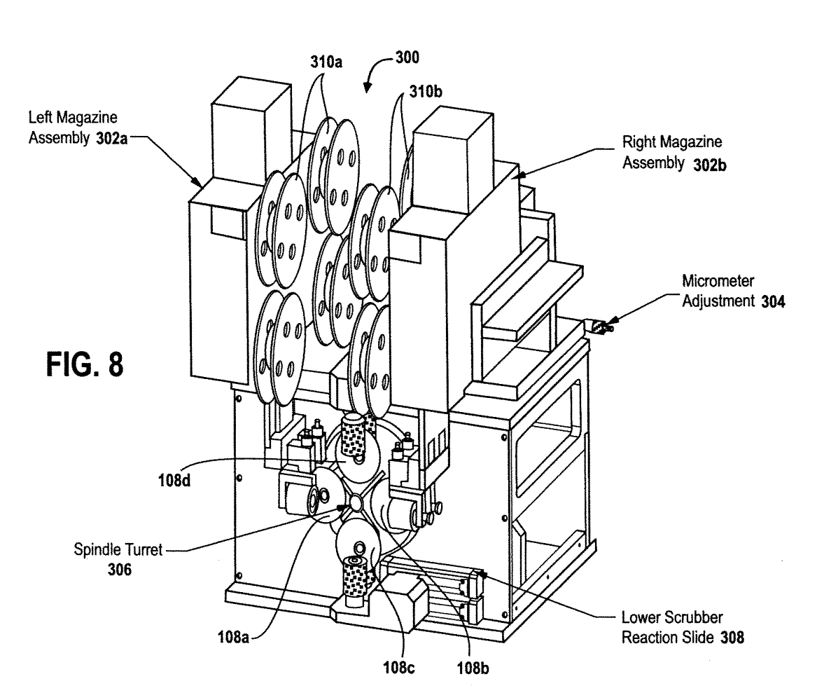

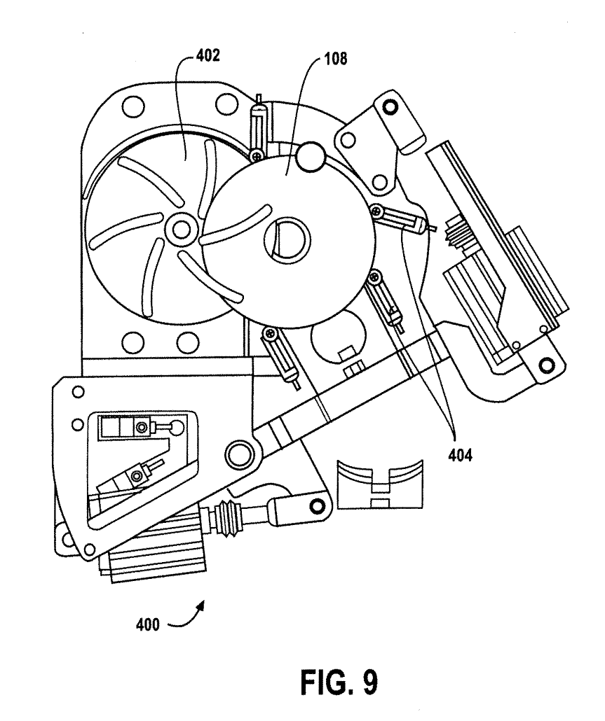

Still referring to FIG. 1, in operation 24, pads having different degrees of roughness may be used within a cascade scrubber in order to achieve enhanced results. That is, the pad utilized for the scrubbing operation in operation 24d may initially be a rougher or harder pad and the downstream pads may be softer. Thus, the initial rougher pad will actually planarize the surface of the HDD and the downstream pads will provide the washing or cleaning functions. One skilled in the art will appreciate that the enhanced polishing and post-polishing operations described with regard to operations 24a and 24d, may be integrated into operations 20 and 22 in an alternative embodiment. In addition, the embodiments described in further detail with reference to FIGS. 8 and 9 enable incorporation of a standalone polish module integrated into the process, e.g., at operations 22 and/or 24, to enhance the cleaning of the disks.

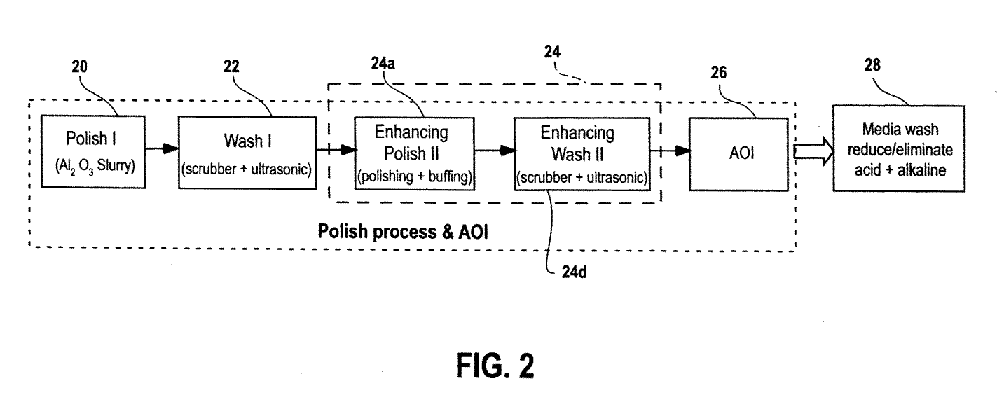

FIG. 2 is a flowchart diagram illustrating the enhanced polish and washing operation in accordance with one embodiment of the invention. The method initiates with a first polish operation 20, where an aluminum oxide slurry may be utilized to planarize the surfaces of the hard drive disk. Upon completion of the first polish operation the substrates are transferred to a scrubber for washing in operation 22. In one embodiment the washing operation is performed through a cascade scrubber as described in more detail below where pads having different surface roughness are applied to the substrate as the substrate moves along the cascade scrubber. In addition, the washing operation may utilize an ultrasonic or megasonic cleaning operation, where acoustic energy is utilized to clean the polished HDDs. From washing operation 22 the HDDs proceed to the enhanced polishing and washing operations as illustrated through operation 24. In operation 24 an enhanced polishing operation occurs as illustrated by operation 24a. The enhanced polish operation 24a includes a polishing and buffing operation. The enhanced wash operation in operation 24d provides for a scrubbing and ultrasonic cleaning operation in accordance with one embodiment of the invention. From operation 24d the HDDs are inspected through an AOI tool in operation 26. Upon completion of operation 26 the HDDs are provided for further processing in order to deposit media onto the surfaces of the cleaned disks.

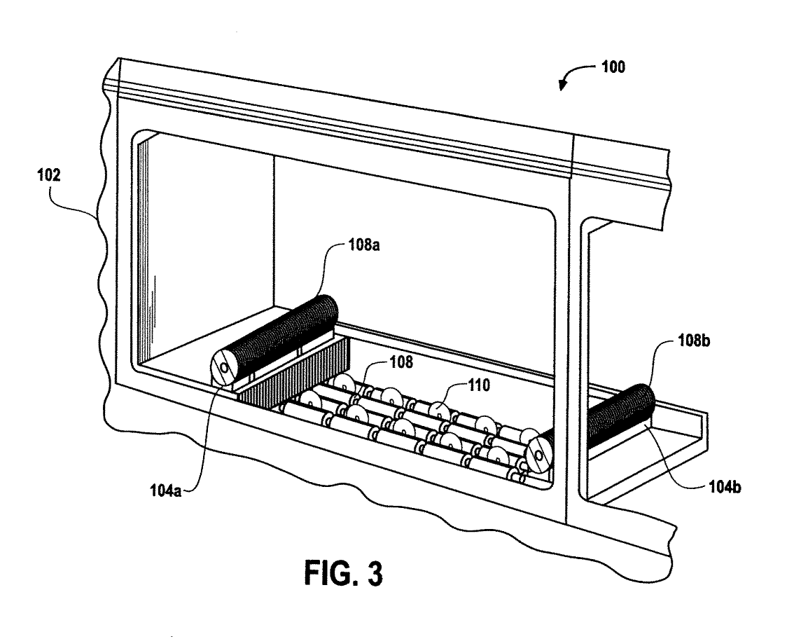

FIG. 3 illustrates a cascade scrubber system 100 within a system enclosure 102 in accordance with one embodiment of the invention. In the illustrated embodiment, three lines of cascade scrubber assemblies are configured in parallel within a single system enclosure 102 to create the cascade scrubber system 100 that can be operated as a discrete cleaning system (e.g., stand alone too)), or as an integral unit or module of a larger wafer or disk preparation or fabrication system. As will be discussed below in greater detail, the embodiments of the present invention are not limited to any one type of substrate 108. Therefore, the disclosed embodiments should be read in light of equal or modified application to both semiconductor wafers and storage media such as hard disks (e.g., aluminum disks, glass disks, etc.).

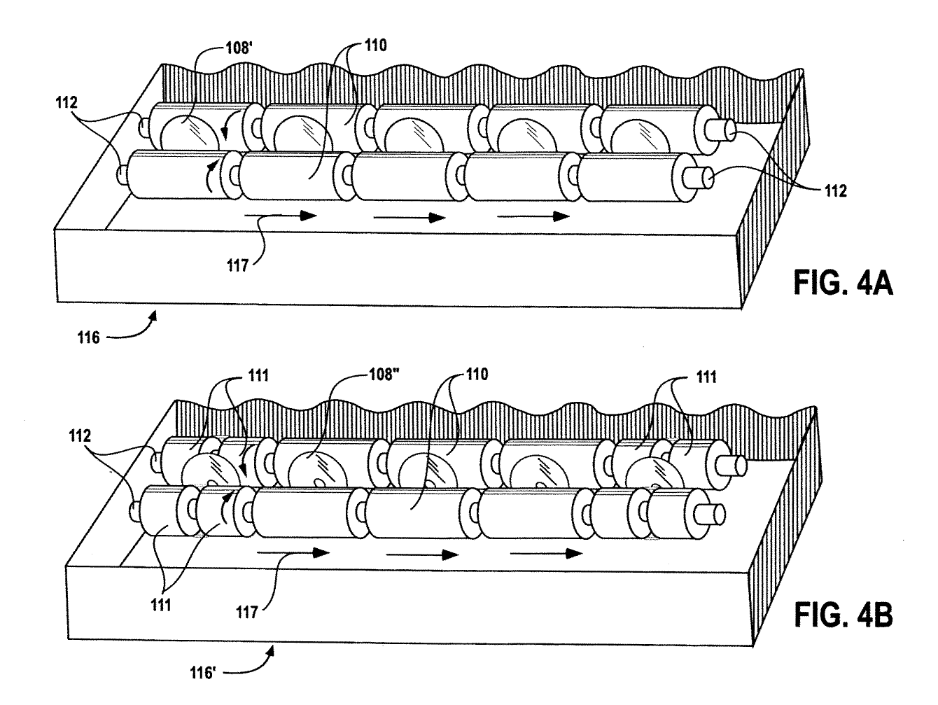

The illustrated cascade scrubber system 100 employs 3 lines of cascade scrubber assemblies (see FIGS. 4A and 4B) in accordance with one embodiment of the invention. Multiple lines of cascade scrubber assemblies are configured to process substrates 108 in batches to increase throughput and efficiently utilize system resources. The three lines illustrated represent one configuration, and other embodiments can be configured with 5, 6, or as many or few lines as resource and processing needs dictate.

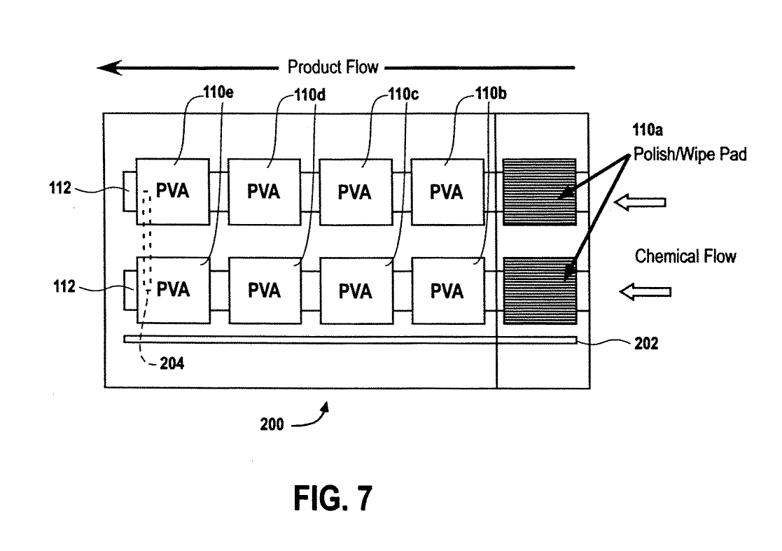

In FIG. 3, substrates 108 to be cleaned (shown as substrates 108a) are loaded into one of the three lines of cascade scrubbers from a substrate indexing cradle 104a. The substrate 108 is placed in the gap defined between the pair of rollers 110 and travels the length of the cascade scrubber assembly which consists of five zones in the illustrated example. As the substrate 108 travels through each zone, the processing by the pairs of rollers progressively cause the substrate 108 to become cleaner. After being processed through the scrubber assembly line, the substrate 108 is then removed from the last zone of the cascade scrubber assembly, and placed with cleaned substrates 108 (shown as substrates 108b) in a clean wafer substrate indexing cradle 104b. In one embodiment, the brushes utilized for the different zones are different as described below with reference to FIG. 7.

FIGS. 4A and 4B each show a single cascade scrubber assembly 116, 116′ in accordance with two embodiments of the present invention. In FIG. 4A, a substrate cascade scrubber assembly 116 for semiconductor wafer applications is illustrated. The wafer cascade scrubber assembly 116 provides a longitudinal scrubbing sequence divided into a series or “cascade” of zones in which a wafer 108′ is progressively cleaned as it proceeds through the wafer cascade scrubber assembly 116 from one zone to the next. In each zone, a pair of rollers 110 configured with selected preparation surfaces (e.g., brushes, pads, and the like) processes the wafer 108′ oriented in a vertical position. The rollers 110 are mounted on mandrels 112 and each roller 110 is configured to receive a brush, pad, or other preparation surface. By way of example, in a wafer or disk cleaning application, brushes can be used. The brushes may be made of PVA foam, or may also be urethane or other suitable material, and molded into a cylindrical foam sleeve that mounts on the roller 110. Each roller 110 contains a plurality of holes. Deionized (DI) water or other fluid is introduced under pressure into the mandrel 112 bore, so as to flow out under pressure through the roller 110 apertures and then through the brush. It should be appreciated that this helps preserve the brush life. For more information on fluid delivery techniques, reference can be made to U.S. Pat. No. 5,875,507, entitled “Wafer Cleaning Apparatus,” issued Mar. 2, 1999, and U.S. Pat. No. 6,247,197 entitled “Brush Interflow Distributor,” issued Jun. 19, 2001. Both U.S. Pat. No. 5,875,507 and U.S. Pat. No. 6,247,197 all of which are incorporated herein by reference.

The mandrels 112 are configured as parallel shafts in a horizontal orientation. In one embodiment, the rollers 110 are mounted on the mandrels 112 to form the series or cascade of zones in which the scrubbing, cleaning, or other substrate preparation is accomplished. In another embodiment, the rollers 110 are mounted on the mandrels 112 to form a continuous preparation surface along the length of the mandrels 112. FIG. 4A illustrates a cascade of 5 zones, but other configurations can be utilized to accommodate the desired preparation, process application, or facility resource. Further, other embodiments of the present invention include a vertical orientation of the mandrels, or in some other angled plane, e.g., a 45-degree incline. However the mandrels 112 may be oriented, the cascade of cleaning zones progress from “dirtier” to “cleaner” as the wafer advances through the cascade scrubber assembly 116. In a vertical or inclined orientation, gravity enhances the progressive removal of particulates by the rinsing, cleaning, or other preparation fluids.

The parallel mandrel 112 pairs are configured to rotate and are attached to the cascade scrubber system 100 by conventional techniques. In one embodiment, the mandrels 112 are attached such that the spacing between the mandrels 112 is adjustable. The adjustable configuration allows for variation of pressure between the preparation surface (e.g., pad or brush) and the semiconductor wafer 108′, and also allows for the use of multiple sizes of pads or brushes as dictated by the wafer 108′ preparation process or disk 108″ preparation process. As discussed above, the cascade scrubber assembly 116 can be used for buffing or polishing operations in addition to scrubbing and cleaning operations. The adjustable mandrels 112 allow adjustment of the preparation surface, and of the pressure applied to the substrate 108 during preparation depending on the desired process. Further, the rate of rotation of the mandrels is also adjustable.

In one embodiment, the mandrels 112 are configured to be counter-rotational. The preparation surfaces are applied with equal force on both sides of the vertically oriented wafer 108′. By way of example, brushes mounted on the rollers 110 rotate towards each other. A wafer 108′ is positioned in the nip, i.e., the gap defined between the opposing brushes, and the rotating brushes push inwardly and downwardly on the wafer 108′ equally on each side as the brushes counter-rotate inward towards the nip. At the nip, the brush rotation is downward. This pushes the wafer 108′ downward onto the substrate drive track which is discussed in more detail in U.S. Pat. No. 6,625,835, which is incorporated herein by reference.

FIG. 4A shows a wafer 108′ in each of the multiple zones of the cascade scrubber assembly 116. The substrate drive assembly (described in detail below) transitions the wafers 108′ from one zone to the next. In FIG. 4A, the transition through the cascade scrubber assembly 116 is in direction 117, and can proceed as interrupted transitions from zone to zone, or as a continuous transition from one end to the other. As will be described in greater detail below, one embodiment of the present invention incorporates a “curtain” of DI water, chemicals, or other suitable fluid between each zone. As the wafers 108′ progress through the cascade scrubber assembly 116, they are progressively cleaned or otherwise prepared before being removed from between the rollers 110 that define the final zone. The use of multiple cascaded zones as well as multiple cascade scrubber assemblies 116 configured as a unit or module increases both the quality of the selected process as well as the throughput of wafers being processed.

FIG. 4B illustrates the same cascade scrubber assembly 116′ as shown in FIG. 4A configured to process disks 108″. In FIG. 4B, the first and last zones of the disk cascade scrubber assembly 116′ are configured with a split roller 111, and associated split preparation surfaces, to accommodate the end effector used for common media disks 108″. As is described in greater detail below, a disk engagement finger on a pick and place assembly attaches to the hole in the center of a disk 108″. The split roller 111 shown in FIG. 4B accommodates the disk engagement finger as the disk 108″ is positioned between the split rollers 111 in the first zone of the disk cascade scrubber assembly 116′, and when the disk engagement finger attaches to the disk 108″ to remove the disk 108″ from the last zone. The remainder of the design and function of the disk cascade scrubber assembly 116′ illustrated in FIG. 4B is identical to the wafer cascade scrubber assembly 116 described in reference to FIG. 4A.

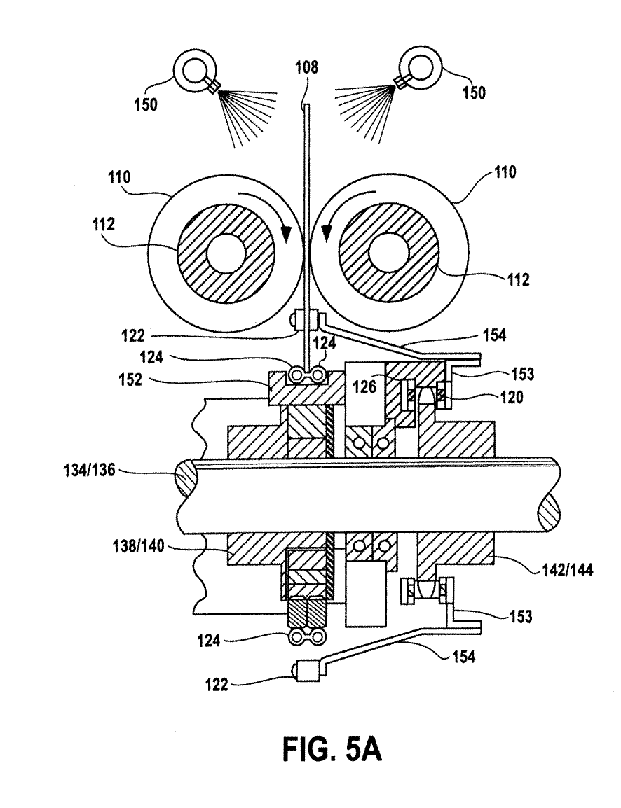

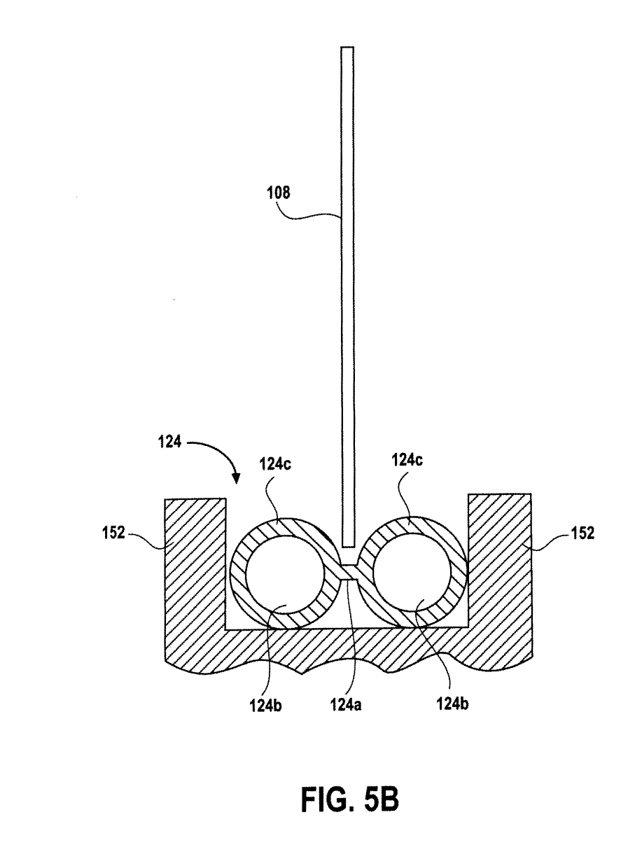

FIG. 5A shows a cross-sectional view of one zone of a cascade scrubber assembly 116/116′ (see FIGS. 4A, 4B), in accordance with one embodiment of the present invention. As discussed in detail above, a substrate 108 is positioned between two counter-rotating rollers 110 mounted on mandrels 112. The rollers 110 are covered by a substrate preparation surface such as a pad, a brush, and the like, and rotate towards each other to apply an inward and downward force equally on both sides of the substrate 108. The substrate 108 transitions through the cascade scrubber assembly 116/116′ in track 124. Guide rollers 122 are suspended above the substrate drive assembly 131 (see FIGS. 3A, 3B, 3C) on guide roller arms 154 which are attached to the roller drive chain 120 by arm brackets 153. The roller drive chain 120 is isolated from the edge rotational drive belt 124, the substrate 108, and the substrate preparation region by a roller chain guard 126. The guide rollers 122 allow the substrate 108 to rotate and provide lateral support to the substrate 108 as they transition the substrate 108 along the cascade scrubber assembly 116/116′ from one zone to the next driven by the roller drive chain 120.

In one embodiment, nozzles 150 are mounted above and on either side of the substrate 108. The nozzles 150 are configured to dispense fluids including DI water, chemicals, and microabrasives in suspension (e.g., slurry) depending on the desired function which can be any of buffing, polishing, scrubbing, cleaning, rinsing, and the like. In another embodiment, the nozzles 150 are configured to dispense fluids at points just above and along the nip of the brushes or other preparation surfaces on either side of the substrate 108. As discussed above in reference to FIGS. 4A and 4B, an embodiment of the present invention also provides for liquids to be dispensed through the mandrels 112, the rollers 110, and through the preparation surface. Additionally, nozzles 150 are configured in one embodiment to dispense a “curtain” of spray (e.g., chemicals or DI water) through which the substrate 108 must pass when transitioning from one zone to the next. The cascade scrubber system 100 (see FIG. 3) is designed to progress from dirtiest to cleanest as the substrates 108 transition through each zone in a cascade scrubber assembly 116/116′ (see FIGS. 4A, 4B). The curtain of spray provides a final rinse as the substrate 108 exits one zone and transitions to the next, thereby maintaining the dirty to clean configuration.

The edge rotational drive belt or track 124 travels in a track slider bed 152. FIG. 5B shows a detail view of the track 124 in accordance with one embodiment of the invention. The track 124 is constructed of two tubular structures, oriented parallel to each other and joined by a short connector section 124a. Instead of forming a sharp “V” or apex at the point of connection, the short connector section 124a forms a short bridge between the two tubular structures. Thus formed, the track 124 consists of two parallel inner hollow cores 124b, an outer surface 124c, and the short connector section 124a. The track is preferably constructed of a polymer material to provide minimum particulate generation, maximum flexibility, and superior gripping to frictionally engage the edge of the substrate 108. The track must be flexible enough to accommodate adjustment as described above with reference to FIG. 5B. Other examples of materials used in the construction of the track include rubber, polyurethane, and the like.

The track 124 travels in the track slider bed 152 and supports the substrate 108 in a vertical orientation with the edge of the substrate 108 positioned in between the two parallel tubular structures over the short connector region 124a. This provides sufficient contact region to frictionally engage the substrate 108 edge in order to apply rotation while minimizing contamination or masking from the preparation process. The track slider bed 152 is preferably constructed of plastic or polymer for minimum friction between the track 124 and the track slider bed 152. The track slider bed 152 must be of sufficient strength to maintain the position of the track 124 under the stress of both increased pressure caused by displacing the track slider bed 152 to accommodate preparation of smaller substrates 108, as well as the downward force caused by the rollers 110 during the preparation processes.

FIG. 5B shows the processing of larger substrates 108 as might be used in larger semiconductor wafers in accordance with one embodiment of the present invention. Accordingly, the substrates 108 are positioned between wider pairs of guiding rollers 122, and the belt elevation plate 155 is shown in the lowered position. In the lowered position, the track slider bed 152 is approximately level with the top of the pulleys that connect the track 124 to drives 134 and 136.

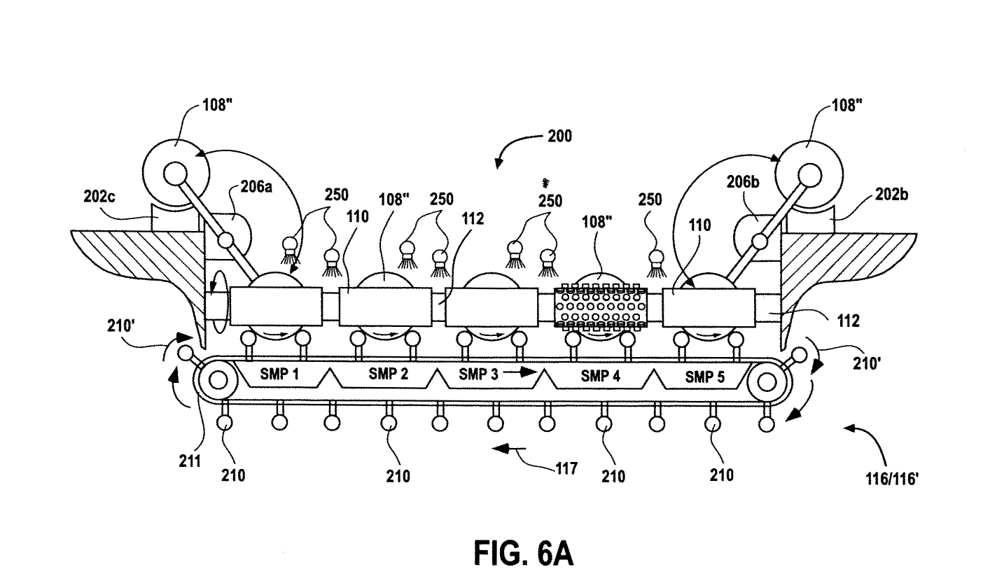

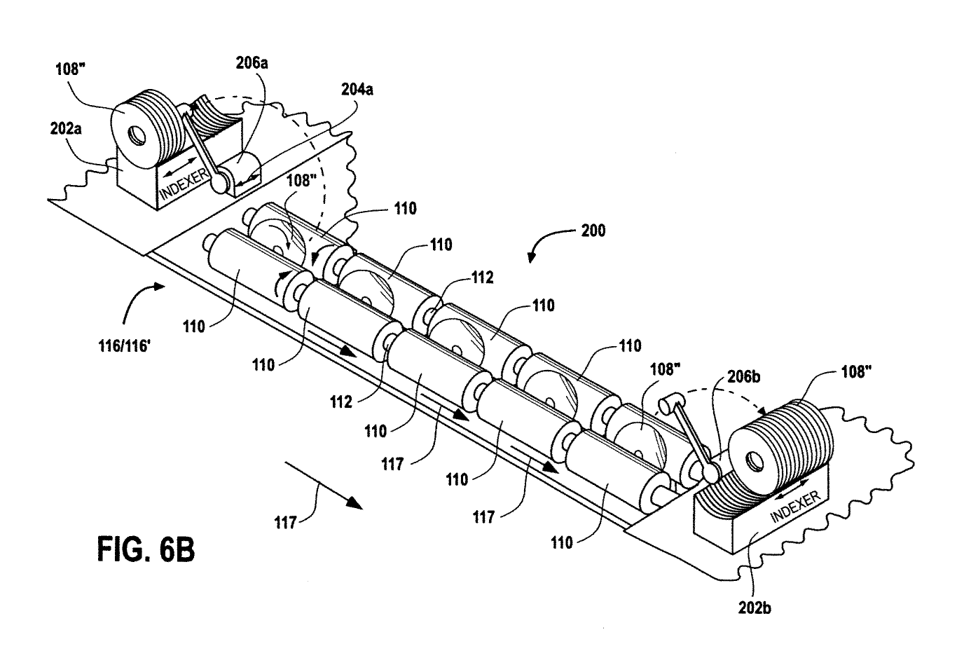

FIG. 6A illustrates an alternative cascade scrubbing system 200, in accordance with one embodiment of the present invention. The alternative cascade scrubbing system 200 is shown in a cross-sectional view to illustrate how a plurality of rollers 110 are arranged along a mandrel 112. As mentioned previously, the rollers 110 are covered with a preparation surface and are configured to scrub or prepare substrates 108 as they progress along the plurality of rollers 110 from one zone to the next along the cascade scrubber assembly 116/116′. In this embodiment, a pick-and-place robot 206a is configured to pick a disk 108″ from an indexer 202c, and then place the disk 108″ between the first pair of rollers 110. As shown, the pick-and-place robot 206a will rotate about an axis and is configured to index to the proper location of the indexer 202c, and then swing in an arc to place the disk 108″ between the first pair of rollers 110 in the first zone of the cascade scrubber assembly 116/116′.

Once the pick-and-place robot 206a places the disk 108″ in the proper location, the disk 108″ will be engaged between a pair of rotating edge wheels 210. The rotating edge wheels 210 are attached to a belt 211. As shown, the belt 211 will be rotating in a clockwise direction such that the rotating edge wheels 210 will move a disk 108″ from a dirty side at one end of the cascade scrubber assembly 116/116′ to a clean side on the other end of the cascade scrubber assembly 116/116′. At the same time, the rotating edge wheels 210 are configured to have a wheel rotation direction 210′. The wheel rotation direction 210′ is also configured to be in a clockwise direction. The clockwise direction of the rotating edge wheels 210 are configured to cause a disk 108″ to rotate in a counter clockwise direction as it transitions through the cascade scrubber assembly 116/116′. Accordingly, each disk 108″ that is loaded into the alternative cascade scrubbing system 200 will be scrubbed between each pair of rollers 110 as it progresses through the cascade scrubber assembly 116/116′.

Also shown in FIG. 6A is a plurality of sumps (SMP 1-SMP 5). The plurality of sumps are arranged such that there is one sump for each zone, and each sump is directly below a pair of rollers 110. In a preferred embodiment, each sump is configured to drain into a previous sump such that fluids being applied and coming off of the rollers 110 and disk 108″ will flow into a previous sump. For example, fluids draining from the final zone of the cascade scrubber assembly 116/116′ will flow into the previous sump (i.e., SMP 4). The drain of fluids from the SMP 4 will then drain into SMP 3, and the fluids of SMP 2 will flow into SMP 1 before being drained out of the system. The sumps therefore are configured to enable dirtier fluids to migrate to the beginning of the cascade scrubber assembly 116/116′ and maintaining the desired dirty to clean configuration of the alternative cascade scrubbing system 200.

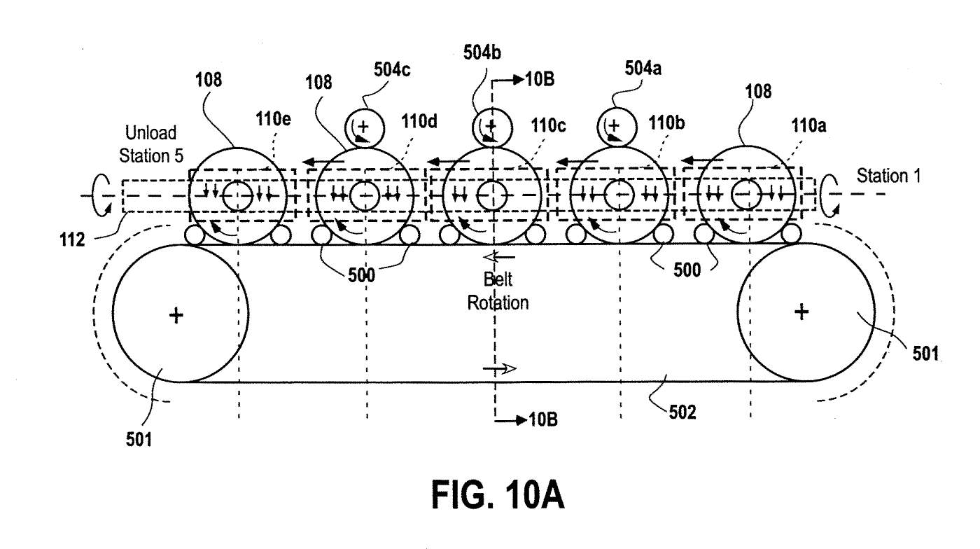

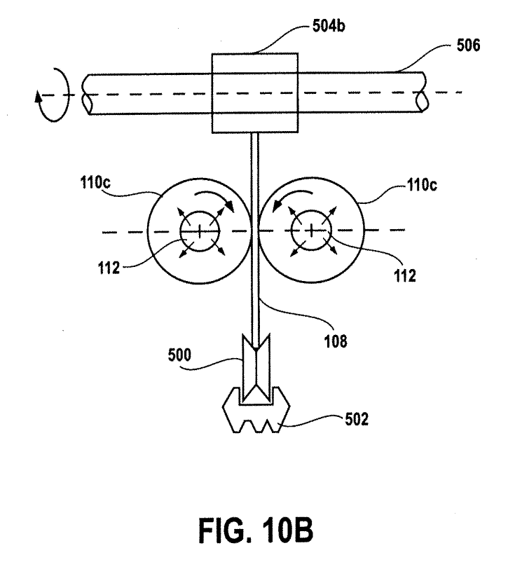

FIG. 6B illustrates a three-dimensional view of the alternative cascade scrubbing system 200. From this view, the indexer 202a is shown including a plurality of disks 108″. Also shown is an indexer 202b having a plurality of disks 108″ which have been scrubbed through the alternative cascade scrubbing system 200. The pick-and-place robot 206a is configured to also index in a direction shown as 204a to enable an edge of the pick-and-place robot 206a to engage a particular disk 108″. The indexers 202a and 202b are also configured to move such that the pick-and-place robot 206a and 206b can access the correct disk 208 and either pick or place the disk 108″ from the indexer 202a or in the indexer 202b. Once the pick-and-place robot 206a places the disk 108″ between the rollers 110 of the first zone, the disk 108″ will be engaged on the rotating edge wheels 210 as shown in FIG. 10A. Thus, the disk 108″ will transition through each zone until it reaches the final zone of the cascade scrubber assembly 116/116′. After the disk 108″ has been processed by the last set of rollers 110, the pick-and-place robot 206b removes the disk 108″ from between the rollers 110 and places the clean disk 108″ into the appropriate location in the indexer 202b.

FIG. 7 is a simplified schematic diagram illustrating an orientation of one row of brushes for a cascade scrubber in accordance with one embodiment of the invention. The portion of cascade scrubber 200 illustrates brushes 110a through 110e disposed over a core or mandrel. In the embodiment of FIG. 7, brush or pad 110a is different from the brush utilized for brushes 110b through 110e. In one embodiment, the brush or pad for 110a is softer than the brushes or pads utilized for brushes 110b through 110e. Brush or pad 110a may be composed of polyvinyl alcohol (PVA) or felt in one embodiment. In this embodiment, the softer material will enable cleaning of the edge defined in the inner aperture, as well as cleaning of the outer edges of the HDD. Additional edge cleaning brushes or wheels may be employed for the outer edges of the HDD. The brush or pad for 110b is rougher or harder than the brushes utilized for brushes 110c through 110e in one embodiment. Thus, the hard drive disk may initially be planarized when disposed into the cascade scrubber by the rougher brushes of brush 110b. Brushes 110c through 110e may be composed of polyvinyl alcohol (PVA), while the material for brushes 110b is a nylon, polyurethane, or IC 1000 pad in accordance with one embodiment of the invention. Thus, as the HDD proceeds toward brush 110e, the HDD surface is being cleaned from the initial planarization operation that occurs between brushes 110b. In another embodiment, brushes 110c-110e may each be composed of different material or there may be a combination of material used for the various brushes. For example, a third material may be used for one of brushes 110c-110e.

Still referring to FIG. 7, cascade scrubber 200 includes an edge cleaner 204 and pad conditioner 202. In one embodiment, edge cleaner 204 is a bar that can be adjusted so that a pad material on the edge cleaner 204 contacts the edge of the disk as the disk passes the edge cleaner. Edge cleaner 204 may be placed at any point along the travel path of the disk in the cascade scrubber and is not limited to the illustrated position. Further details on edge cleaner 204 are discussed with regard to FIGS. 10A-12. Pad conditioner 202 is utilized to condition the brushes as the brushes are cleaning the disks. Pad conditioner 202 may be a bar that moves against the surface of the pads and roughens up the pads to recondition the pads. It should be appreciated that while a single pad conditioner is illustrated, each mandrel 112/brush 110a-e may have a pad conditioner associated with mandrel/brush.

The wafer edge, where deposited films terminate and overlap with underlying materials, has been identified as a primary source of defects. Particles or films are left on the bevel edge region of the disk after prior processing (polish, plating, etc.) that can fall off prior or during subsequent fabrication operations. The unwanted residual particles or material may cause, among other things, defects such as scratches on the disk surface. In some cases, such defects may cause the finished disks to become inoperable. In order to avoid the undue costs of discarding substrates/media, it is therefore necessary to clean the bevel region adequately and efficiently after fabrication operations that leave unwanted residue on the surfaces. This can be accomplished by the embodiments described with regard to FIGS. 10A-12.

It should be appreciated that the incorporation of the polish operation into the cascade scrubber enables the disk surface to remain wet, i.e., is not able to dry between operations, and immediately be cleaned through the PVA brushes so that embedded particles are essentially eliminated. In another embodiment, transportation to a stand-alone module, as described with regard to FIGS. 8 and 9 also enables enhanced cleaning due to maintaining the wet environment and/or constantly applying a fresh polishing member surface to the surfaces of the substrates being cleaned.

FIG. 8 is a simplified schematic diagram illustrating an alternative buffing/polishing module for use in the enhanced polishing washing scheme in accordance with one embodiment of the invention. Module 300 in this embodiment is a standalone piece of equipment where the planarized disks are transferred after the first polish operation. Being modular, module 300 can be incorporated within the enhanced buffing/polishing washing scheme in accordance with one embodiment of the invention. Left and right magazine assemblies 302a and 302b and corresponding reels 310a and 310b provide a tape material or polishing member that is continually refreshed to polish and/or planarize substrates 108a and 108b that are vertically oriented on spindle turret 306. The tape material may be a material that is rougher than the PVA brushes as discussed above in one embodiment. In an alternative embodiment, the tape material may be softer than the PVA. The tape material is supplied from one reel and wraps around a roller to return to another reel in this embodiment and is not illustrated in FIG. 8 in order not to obscure the structural features of the module. It should be appreciated that the tape material may be any suitable polyurethane material, nylon material, or felt material. As illustrated, module 300 includes an upper and lower scrubber for performing a wipe operation on substrates 108d and 108c. In one embodiment, the opposing sides of the substrates are processed contemporaneously. In another embodiment, spindle turret 306 may rotate around a central axis that is external to each of the substrates, so that after a substrate has been polished, the substrate is rotated and can be wiped by the upper or lower scrubber units. Lower scrubber retraction slide may be utilized to position or enable the lower scrub unit. Module 300 is equipped with pressure transducers which are utilized to adjust the pressure applied by the tape/polishing roller units on the substrates undergoing the polishing operation. Micrometer 304 is used to set the alignment of the left or right magazines so that the respective rollers (or tapes) won't interfere with the respective spindles that drive or rotate the substrates 108a and 108b. After the substrates 108a and 108b have been polished and planarized by module 300, the substrates can be disposed into the cascade scrubber for further planarization, polishing, and cleaning. It should be appreciated that the incorporation of the modular polish operation with the cascade scrubber enables the disk surface to remain wet, i.e., is not able to dry between transfer operations between modules, and immediately be cleaned through the PVA brushes so that embedded particles are essentially eliminated.

Thus, with an intermediate pre-cleaner/surface conditioner tool, such as module 300 of FIG. 8, a constantly fresh cleaning tape is exposed to he surfaces of the substrate being cleaned. In one embodiment, the substrate may be planarized and transferred to a first station of module 300. At this first station, opposing sides of the substrate are polished as the substrate rotates around an axis of the substrate. In one embodiment, nozzles provided proximate to the contact point of the tape material on each surface of the substrate deliver a fluid to assist in the cleaning. The fluid may range from anon-reactive fluid, such as deionized water, to commercially available and proprietary chemical cleaning solution utilized in the semiconductor and disk drive industries, and even reactive acids, such as hydrofluoric acid and hydrochloric acid. The polishing member or tape material contacting each surface of the disk continuously advances in order to ensure that the disk surface is exposed to a fresh or unused portion of the tape material. It should be noted that the advancing of the polishing members are independent of each other. Upon completion of the operation the substrate is transferred to a second station of the polishing module. At the second station a wipe operation may occur. In the wipe operation a fluid may also be delivered to the surface of the substrate in the vicinity of the material contacting the surfaces of the substrate through a corresponding nozzle in communication with a fluid supply.

It should be appreciated that the two sets of rollers positioned against a backside of the polishing member for the opposing sides of substrates 108a and 108b may provide an independently variable pressure to the surface of the corresponding substrate. That is, each roller may be in communication with a fluid source and a flexible outer surface of the roller can be made to expand and contract to influence the pressure placed on the polishing member against the surface of the substrate through the introduction of the fluid into a cavity of the roller. Additionally, the rollers corresponding to the wipe operations for substrates 108c and 108d may also similarly apply a variable pressure to the surface of the corresponding substrates. It should be appreciated that while the rollers corresponding to substrates 108c and 108d are illustrated as having a surface for wiping the substrate and not having a continuous supply of a polishing tape attached thereto, this is not meant to be limiting. That is, the rollers corresponding to substrates 108c and 108d may also be in communication with corresponding reels and magazines so that a polishing member or tape may be continuously refreshed and utilized to wipe the surfaces of substrates 108c and 108d.

FIG. 9 is a simplified schematic diagram illustrating a batch scrubbing module that may be utilized to perform the enhanced polishing and washing operations in accordance with one embodiment of the invention. Module 400 would also be a standalone unit where the planarized disks are transferred to. Substrate 108 is supported on an arm assembly and contact a surface of pad 402. Pad 402 is of a material that is preferably rougher or softer than the PVA brushes, as discussed above with reference to FIG. 8. Module 400 includes edge cleaners 404 which can polish the peripheral edge of substrate 108. In one embodiment, pad 402 is a variable pressure brush/pad as described in U.S. patent application Ser. No. 12/694,188, the contents of which are herein incorporated by reference. As mentioned with reference to FIG. 8, fluid may be delivered to the substrate surfaces through nozzles positioned proximate to the substrate surfaces. Thus, the standalone modules of FIGS. 8 and 9 may be utilized with the process flow of FIG. 1 and incorporated after the polish 1 or polish 2 operations in one embodiment.

FIG. 10A is a simplified schematic diagram illustrating a wafer cleaning cascade station having integrated edge cleaners in accordance with one embodiment of the invention. The belt 502 rotates around and rollers 501 and rotates spinning wheels 500 in one embodiment. Substrates 108 are loaded into station one and exit from station five. Brushes 110a through 110e scrub and create a downforce while belt 502 rotates substrates 108. As described above, pads 110a through 110e are disposed around mandrel 112. In one embodiment, a 5 second scrub is performed at each station prior to having the disk transported to a next station. One skilled in the art will appreciate that any suitable amount of time, more or less than 5 seconds, may be experienced at each station. In addition, differing amounts of time may be experienced at differing stations. FIG. 10A illustrates an exemplary embodiment with the edge scrub brush pads located at stations two, three, and four. Edge scrub brush pads 504a through 504c may be composed of the same or differing material similar to the embodiments described with regard to brushes 110.

FIG. 10B is a simplified schematic diagram illustrating a cross-sectional view through station three of FIG. 10A in accordance with one embodiment of the invention. Brush 110c is disposed over mandrel 112 and the pair of opposing brushes rotate in a manner to provide a downforce to substrate 108. Spinning wheels 500 rotate the disk as driven by belt 502. Edge scrub brush 504 disposed around mandrel 506 rotates to scrub an edge of substrate 108. It should be appreciated that mandrel 112 may also function to provide fluid flow through into brush 110c which is then dispersed to substrate 108. In one embodiment the edge scrub brush\pad may be composed of polyvinyl alcohol. In another embodiment each of the three edge scrub stations may have different pads or processes utilized at each station. Of course, there may be more or less than three stations as illustrated in the exemplary diagrams. The brushes used for the edge scrub may have various shapes, may or may not include fluid flow through of a fluid through mandrel 506, and may or may not include deionized waterjet's providing fluid directed toward edge scrub brush 504. In another embodiment the drive for the edge scrub mechanism may be rigid with a clutch where substrate 108 drives the mechanism.

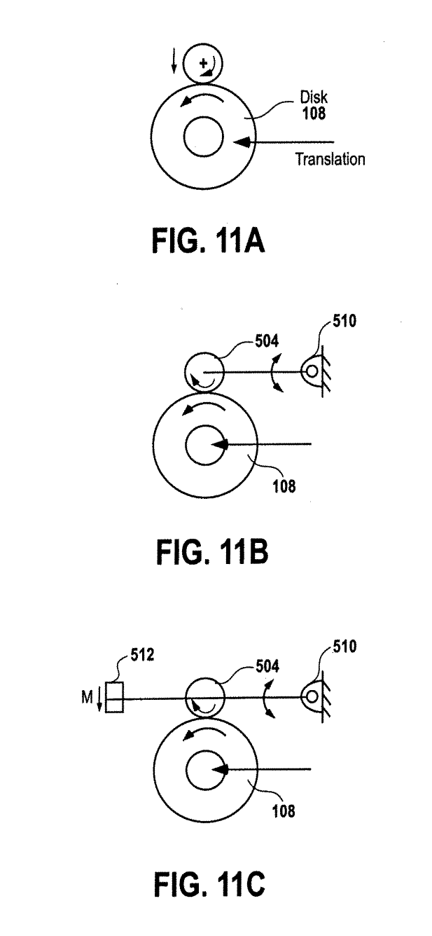

FIGS. 11A through 11C illustrate various embodiments for support of the edge scrub brush mechanism in accordance with one embodiment of the invention. In FIG. 11A the edge scrub brush is fixed with the possibility of being adjusted vertically to set the pressure against the edge of substrate 108. Here, the disk rotation creates the scrub action. In one embodiment, the vertical travel of the scrub brush may be limited between top and bottom stops, and a spring may be used to create downward contact force. FIG. 11B illustrates a cantilevered arm 510 utilizing spring torsion to create a downforce of edge scrub brush 504 against substrate 108. FIG. 11C illustrates an alternative cantilevered arm 510 where the downforce for edge scrub brush 504 against substrate 108 is provided through weight 512.

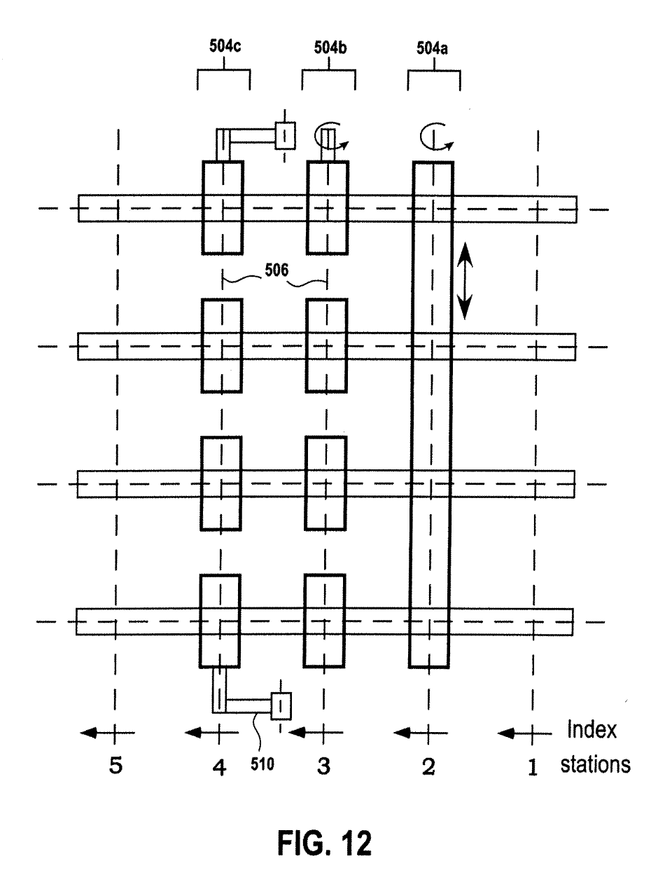

FIG. 12 is a simplified schematic diagram illustrating a top view of a four-lane transport system having edge scrub cleaning capability in accordance with one embodiment of the invention. The four lanes of the transport system each have five stations. Stations two through four are associated with edge scrub mechanisms. Station two is provided with a continuous brush 504a that traverses across all lanes. In one embodiment, the continuous brush 504a can be translated along an axis of the mandrel to spread wear more evenly across the brush during processing operations. The edge scrub brush 504b associated with station three includes individual brushes having a fixed location along each lane. Edge scrub brush 504c traversing across station four also includes individual brushes disposed over mandrel 506. However, edge scrub brush 504c includes a cantilevered arm 510. As mentioned above each of the edge scrub brushes may utilize different brushes or the same brushes.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for cleaning and polishing a disk, comprising;
planarizing the disk;
transferring the planarized disk to a first station of a polishing module;
simultaneously polishing opposing sides of the disk as the disk rotates around an axis of the disk, the polishing including,
continuously advancing a first polishing member contacting a first surface of the disk and a second polishing member contacting a second surface of the disk, the advancing of the first polishing member independent of the advancing of the second polishing member; and
transferring the disk to a second station of the polishing module.

2. The method of claim 1, wherein the polishing further includes,
spraying a fluid proximate to a contact point on the disk for the first polishing member and the second polishing member.

3. The method of claim 1, wherein the transferring includes rotating the disk around an axis external to the disk.

4. The method of claim 1, wherein the first polishing member and the second polishing member are composed of one of felt, polyurethane, or nylon.

5. The method of claim 1, wherein the polishing includes,
adjusting a pressure applied to a back surface of the first polishing member and a pressure applied to a back surface of the second polishing member.

6. The method of claim 1, further comprising:
supporting the disk through a spindle extending through a center opening of the disk.

7. The method of claim 1, further comprising:
rinsing the disk at the second station; and
wiping the disk at the second station.

8. The method of claim 1, further comprising:
transferring the disk to a third station of the polishing module;
simultaneously polishing opposing sides of the disk as the disk rotates around the axis of the disk, the polishing including,
continuously advancing a third polishing member contacting the first surface of the disk and a fourth polishing member contacting the second surface of the disk, the advancing of the third polishing member independent of the advancing of the fourth polishing member, wherein composition of the first and the second polishing members are different than composition of the third and the fourth polishing members.

9. A method for cleaning a disk, comprising;
planarizing the disk;
transferring the disk to a first station of a polishing module wherein the disk is vertically oriented;
contemporaneously polishing opposing sides of the disk as the disk rotates around an axis of the disk;
linearly advancing opposing polishing membranes independently during the polishing, the linearly advancing in an opposing direction to a direction of rotation of the disk;
delivering a liquid to each of the opposing sides proximate to a contact point of each of the polishing membranes during the polishing;
independently adjusting a pressure applied to a backside of each of the polishing membranes during the polishing;
transferring the disk to a second station of the polishing module; and
wiping opposing sides of the disk as the disk rotates around an axis of the disk.

10. The method of claim 9, wherein the linearly advancing provides a continuous supply of unused polishing membranes contacting surfaces of the disk.

11. The method of claim 9, wherein the independently adjusting the pressure comprises:
forcing a fluid into an inner cavity of a roller supporting the polishing membrane.

12. The method of claim 9, further comprising:
transferring the disk to a third station of the polishing module; and
simultaneously polishing opposing sides of the disk as the disk rotates around the axis of the disk.

13. The method of claim 12, wherein the simultaneously polishing comprises:
continuously advancing another pair of polishing membranes contacting the first surface of the disk and the second surface of the disk, the advancing of the another pair of polishing membranes independent of each other, wherein composition of the opposing polishing membranes is different than composition of the another pair of polishing membranes.

14. The method of claim 9, further comprising:
supporting the disk through a spindle extending through a center opening of the disk.

15. The method of claim 14, wherein the transferring the disk to the second station comprises:
rotating the disk around an axis external to the disk.

16. The method of claim 9, wherein the contemporaneously polishing occurs when the opposing sides of the disks are wet.

17. The method of claim 9, further comprising;
planarizing the disk after the wiping; and
repeating the contemporaneously polishing.

18. The method of claim 17, wherein the wiping comprises;
rinsing surfaces of the disk with deionized water.
